(19) United States
(12) Patent Application Publication
(10) Pub. No.: US 2014/0237938 A1
(43) Pub. Date: Aug. 28, 2014

(54) Method and Apparatus For Assembling Simulated Divided Light Window Grids.

(71) Applicant: Steven L. Reeder, Salisbury, NC (US)

(72) Inventor: Steven L. Reeder, Salisbury, NC (US)

(21) Appl. No.: 13/775,215

(22) Filed: Feb. 24, 2013

(51) Int. Cl. E04F 21/00; E06B 3/68

(52) U.S. Cl. CPC E04F 21/003; E06B 3/685
USPC 52/745.16; 33/194

(57) ABSTRACT

A method and apparatus for easily assembling a simulated divided light window grid is provided. A window gauge having at least one grasping means is provided to quickly assemble the simulated divided light window grid. The simulated divided light window grids are assembled by horizontally and vertically interconnecting the plurality of rigid muntin bars spaced apart using the window gauges. After completing the assembly the window gauges can be easily removed by holding the grasping means on the window gauges.

### BACKGROUND OF THE EMBODIMENT

1. Technical Field of the Invention

The present invention relates to a method and apparatus for assembling simulated divided light window grids. More specifically, the present invention relates to a method and tool for making repeatable assembly of simulated divided light window grids.

2. Description of the Related Art

In view of the constantly rising costs in the building materials industry, it has become increasingly important for builders and material suppliers to find fast and reliable methods and substitute materials to replace existing conventional materials and methods in order to effect economies in building construction without undue sacrifice in quality of construction and in the appearance of the finished product. The use of individual horizontal and vertical muntin bars and other window dividers provide good aesthetic feel, but the existing fabrication methods increases the overall material and labor cost. Increased fabricating costs and increased labor costs result from the use of improper muntin bars and divided light windows. Accordingly, by changing the fabrication methods to produce divided light windows of various sizes, a considerable manufacturing and labor cost savings can be realized by providing repeatable process.

Grids formed by interconnected muntin bars are often installed on glass panes or between glass panes of a double pane or insulated sash window. Typically, these grids are comprised of multiple muntin bars arranged in a grid pattern and interconnected at interior intersecting points by muntin joiners. The grid is then placed between the panes of glass. The periphery of the grid is then mounted to the sash frame, or more typically, to a spacer frame separating the panes, by a series of muntin clips. Muntin bars are often used for decorative purposes to divide light in windows and make a large integral window appear as if it were formed of a number of smaller window panes separated from each other. Decorative muntin bars simulate the colonial style of numerous panes of glass in individual wooden frames. Conventional muntin bars are integrally formed and such muntin bars may be coated in a variety of matching colors to coordinate with the color of the sash of the window; however, these muntin bars are not suited to easily have two distinct colors or textures respectively located on the interior and exterior surfaces of the muntin bar.

One prior art patent is U.S. Pat. No. 4,437,284 issued to Cribben on Mar 20, 1984, discloses a false muntin assembly for converting a single window pane into one having multiple lights by having a muntin bar of desired outside appearance with a central hole and channel lengthwise along the back of the muntin bar, using pin connectors at intersections and in the peripheral sash and adhering snap-fit metal clips to the glazing panel in line with the false muntin design to prevent the false muntin from floating away from the pane. But the muntin assembly is difficult to fabricate and consume more man-hours of work thereby increasing the overall cost of construction.

U.S. Pat. No. 5,274,976 issued to Burkhart on Jan. 4, 1994 relates to a window that contains a decorative grill bar assembly which is mounted atop a single glazing panel to simulate the presence of separate window panes. The grill bar assembly comprises a plurality of hollow metal extrusions which are connected to one another, and to the window frame, by plastic inserts which are press-fit in hollow ends of the grill bars. The inserts are connected to the grill bars and to the window frame by tongue-and-recess connections. The above said window unit does not provide a specialized tool and method to quickly and easily construct the muntin assembly with minimum labor costs.

Similarly, U.S. Pat. Application publication No. 20060026914 by Schultz on Feb. 9, 2006, discloses a muntin grid having a plurality of muntin bars joined at intersecting points to form a grid. The grid further has a plurality of muntin bar ends located near a periphery of the grid, each muntin bar end having a depending tab. A muntin clip is provided for receiving the tab wherein the tab attaches the clip to the muntin bar end. But the muntin grid and the method of forming the grid does not have any tools or novel methods to easily assemble the muntin bars to form the grid.

Hence, it can be seen that there is a need for a new method and tool for assembling a simulated divided light window grid. The needed method and tool would provide unique setup/assembly steps, with minimal labor costs. The needed method and tool would also reduce the necessity of highly skilled labor to assemble the window grid. Moreover, the needed method and tool would also provide good aesthetic feel to the windows with reduced fabrication cost and time.

### SUMMARY OF THE INVENTION

The above-mentioned shortcomings, disadvantages and problems are addressed herein which will be understood by reading and understanding the following specification.

A simulated divided light window grid assembly and a method of assembling the simulated divided light window grid is provided. The simulated divided light window grid assembly comprises a rigid muntin bar having a top portion, a bottom portion, a left elongated edge and a right elongated edge. The rigid muntin bar has a pair of grooved channels extending along the length of the rigid muntin bar, a first grooved channel is positioned near the left elongated edge and a second grooved channel is positioned near the right elongated edge. A simulated divided light window gauge having a top edge, a bottom edge, which are substantially perpendicular to each other, and a left edge and a right edge, that are substantially perpendicular to each other, with grasping means is provided. The simulated divided light window grids are manually assembled by horizontally and vertically interconnecting the plurality of rigid muntin bars by using the simulated divided light window gauges to quickly, accurately, and repeatedly determining the proper spacing of the muntin bars.

The unique features of the system are the ability to easily and quickly construct the simulated divided light window grid assembly with the use of the plurality of simulated divided light window gauges. The horizontal and vertical assembly of the rigid muntin bars leaves a vacant space inside, in-between the rigid muntin bars, and the simulated divided light window gauges are positioned in these vacant spaces. These simulated divided light window gauges helps to easily and repeatedly assemble the simulated divided light window grids. A cross-style connector is used to connect the horizontal rigid muntin bars and the vertical rigid muntin bars. The simulated divided light window gauge is adapted to fit within a grooved channel provided on the rigid muntin bar. The simulated divided light window grid is assembled by joining the plurality of rigid muntin bars to one another to form a grid shape. After completing the muntin bar assembly the window gauges can be easily removed by holding the grasping means on the window gauges and lifting them out of the muntin bar assembly.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a top view of a simulated divided light window grid assembly;

FIG. 2 illustrates a perspective view, showing a top portion and a bottom portion of a rigid muntin bar;

FIG. 3 illustrates a top view of a simulated divided light window gauge with a pair of rigid muntin bars;

FIG. 4 illustrates a top view of the simulated divided light window gauge;

FIG. 5 illustrates a perspective view of the simulated divided light window gauge showing a bottom edge;

FIG. 6 illustrates a perspective view of the simulated divided light window gauge showing a right edge; and

FIG. 7 illustrates an operational flow chart of a method of assembling the simulated divided light window grid in accordance with the aspect of the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

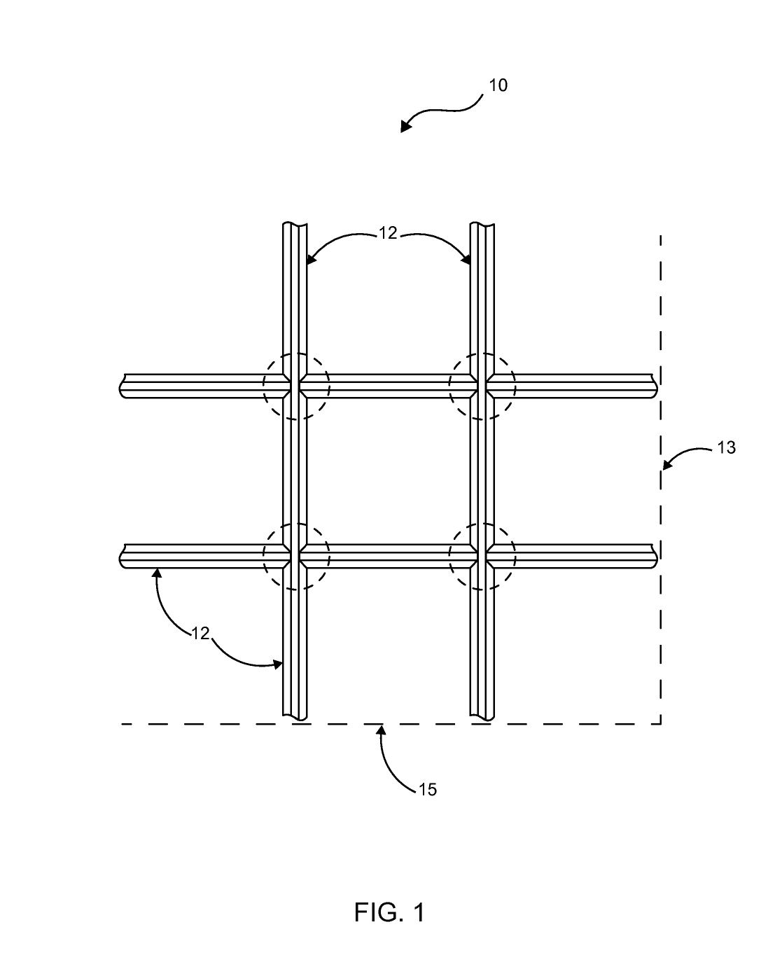

FIG. 1 is a top view of the simulated divided light window grid assembly 10. The simulated divided light window grids 10 are manually assembled by horizontally and vertically interconnecting the plurality of rigid muntin bars 12 and the plurality of simulated divided light window gauges (not shown). The plurality of rigid muntin bars 12 extends in a horizontal direction and in a vertical direction when assembled. The assembly is done on a table with a side elongated edge 13 and a bottom elongated edge 15 where the side elongated edge 13 and the bottom elongated edge 15 are at a 90° right angle to each other. The horizontal and vertical assembly of the rigid muntin bar 12 leaves a vacant space inside, in-between the rigid muntin bars 12, and the simulated divided light window gauges (not shown) are positioned in these spaces. These simulated divided light window gauges (not shown) helps to assemble the simulated divided light window grids 10. A cross-style connector is used to connect the horizontal rigid muntin bars 12 and vertical rigid muntin bars 12. The simulated divided light window gauge is adapted to fit within and be received by an elongated first grooved channel (not shown) and a second grooved channel (not shown) provided on the rigid muntin bars 12. The simulated divided light window grid 10 is assembled by joining the plurality of rigid muntin bars 12 to one another to form a grid shape. Typically, the grid is generally rectangular, but it is understood that the grid may take other shapes as well. Then the cross-style connector is attached to the end of each rigid muntin bars 12 located near a periphery of the overall simulated divided light window grid assembly 10.

Once the cross-style connector is attached to each rigid muntin bars 12, the overall simulated divided light window grid assemblies 10 may be attached to the window frame. As can be seen by the above, according to the invention, the simulated divided light window gauge may be utilized with a variety of rigid muntin bars designs. So long as the grooves on the rigid muntin bars 12 may fit with the edges of the simulated divided light window grid assembly 10, even very loosely. A rectangular or triangular shaped simulated divided light window gauges may also be used with the simulated divided light window grid assembly 10.

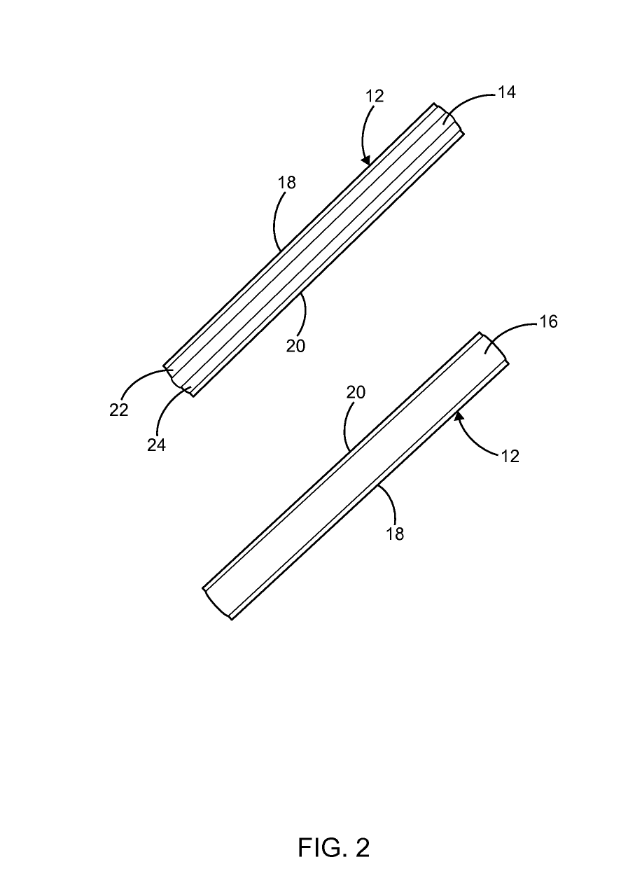

FIG. 2 illustrates a perspective view of the rigid muntin bars 12 having a top portion 14, a bottom portion 16, a left elongated edge 18 and a right elongated edge 20. The plurality of rigid muntin bars 12 has a pair of grooved channels extending along the length of the rigid muntin bars 12. The pair of grooved channels include the first grooved channel 22 positioned near the left elongated edge 18 and the second grooved channel 24 positioned near the right elongated edge 20. Multiple rigid muntin bars 12 are interconnected to form a grid structure 10 for a divided light window. The rigid muntin bars 12 may be made from materials including plastic, PVC, metal and wood. Rigid muntin bars 12 made from PVC are the preferred material for making the grid assembly 10. The rigid muntin bars 12 can be fabricated from sheets of plastic. The plastic muntin bars 12 also reduce the overall weight of the grid structure 10. The groove provided on the rigid muntin bar 12 has a sufficient width to hold the glass plate or a simulated divided light window gauge (not shown) firmly in position. The rigid muntin bar 12 may also have a rectangular or square cross section. The rigid muntin bars 12 extends about the edge of the simulated divided light window gauge (not shown). The simulated divided light window gauge is easily removable after placing the window glass on the rigid muntin bar 12. Therefore the grid structure assembly 10 is comprised of a plurality of interconnecting rigid muntin bars 12. Each of the rigid muntin bars 12 has a generally tubular and hollow construction having the pair of grooved channels. Various means of inter-connecting the rigid muntin bars 12 are available. The connecting means of the rigid muntin bars 12 may include a cross-style connector, which may be utilized to interconnect the rigid muntin bars 12 one another. The rigid muntin bars 12 are so interconnected to form the grid structure 10 which is positioned between the frame limits of the window. The pair of grooved channels extending towards and up to the periphery of the rigid muntin bars 12. The top portion 14 of each of the rigid muntin bars 12 have the elongated first grooved channel 22 and the second grooved channel 24 and the bottom portion 16 has projections of the pair of grooved channels provided on the top portion 14. Thus a plastic sheet can easily be fabricated into the rigid muntin bars 12 of desired size and can be employed to assemble the grid structure 10.

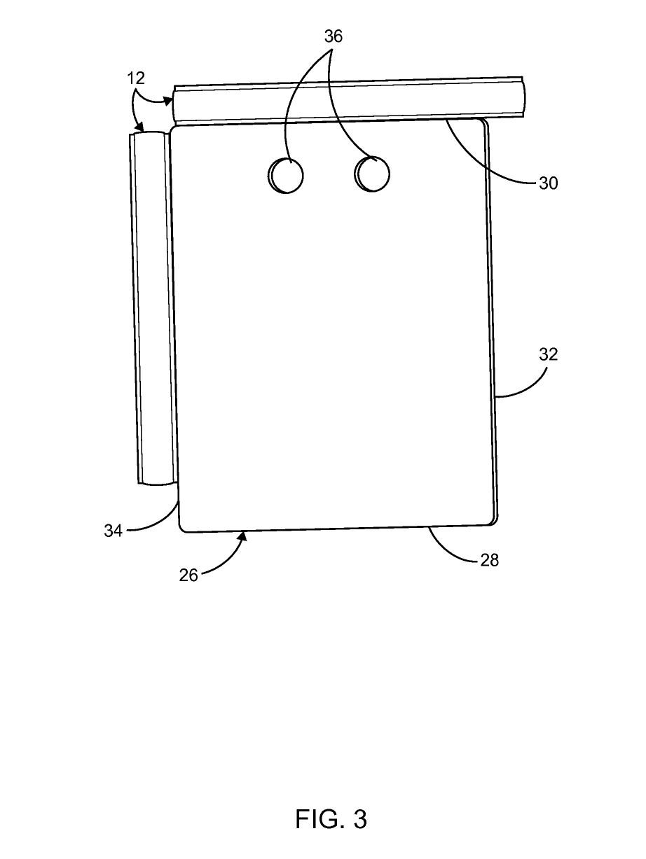

FIG. 3 illustrates a front view of the simulated divided light window gauge 26 with the pair of rigid muntin bars 12. The simulated divided light window gauge 26 may have a rectangular shape having a top edge 28, a bottom edge 30, a left edge 32 and a right edge 34. The simulated divided light window gauge 26 can have different shapes depending on the shape of the window frame and can include a variety of shapes like rectangular, triangular etc. The rectangular or triangular shaped simulated divided light window gauge 26 has a thickness equal to the width of the channel grooves on the rigid muntin bars 12. This ensures proper placing of the simulated divided light window gauge 26 on to the rigid muntin bars 12 to form the grid structure 10. The use of simulated divided light window gauge 26 enables a worker to easily assemble the window frame with the feature of providing divided light through the window. The simulated divided light window gauge 26 has at least one grasping means 36 provided on a surface for easy handling of the gauge 26. The simulated divided light window gauge 26 has a plurality of rounded corners and a pre-defined width and height to fit into an opening in the grid structure 10. The grasping means 36 allows the simulated divided light window gauge 26 to be picked up and removed once the grid structure 10 is completed. The grasping means 36 may be selected from a group consisting of knobs, handles and holes of sufficient size provided on a top side of the simulated divided light window gauge 26 to permit a gloved finger of the worker to pick up the simulated divided light window gauge 26.

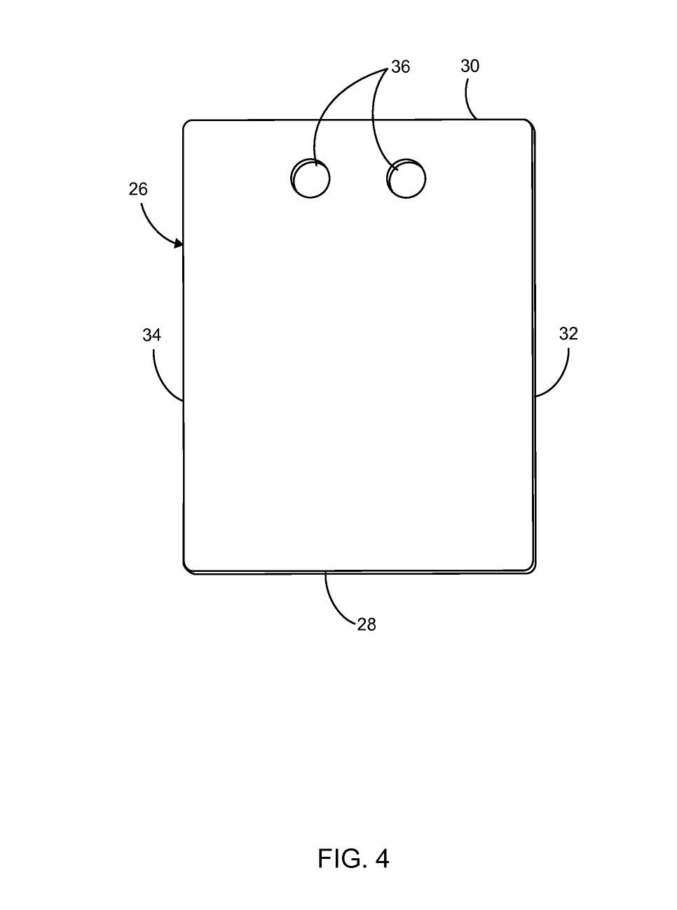

FIG. 4 illustrates a top view of the simulated divided light window gauge 26 showing the grasping means 36. The grasping means 36 used here is a pair of holes near the bottom edge 30 of the window gauge 26. The pair of holes 36 allow the worker to pick up the window gauge 26 with his gloved finger. In another embodiment the grasping means 36 on the window gauge 26 may include three holes for quick and easy handling purposes. In some other embodiments, handles or knobs are attached on the surface of the simulated divided light window gauge 26 for easily assembling the simulated divided light window grid 10. The shape of the window gauge 26 may be triangular in some embodiments for designing unique simulated divided light window grids 10.

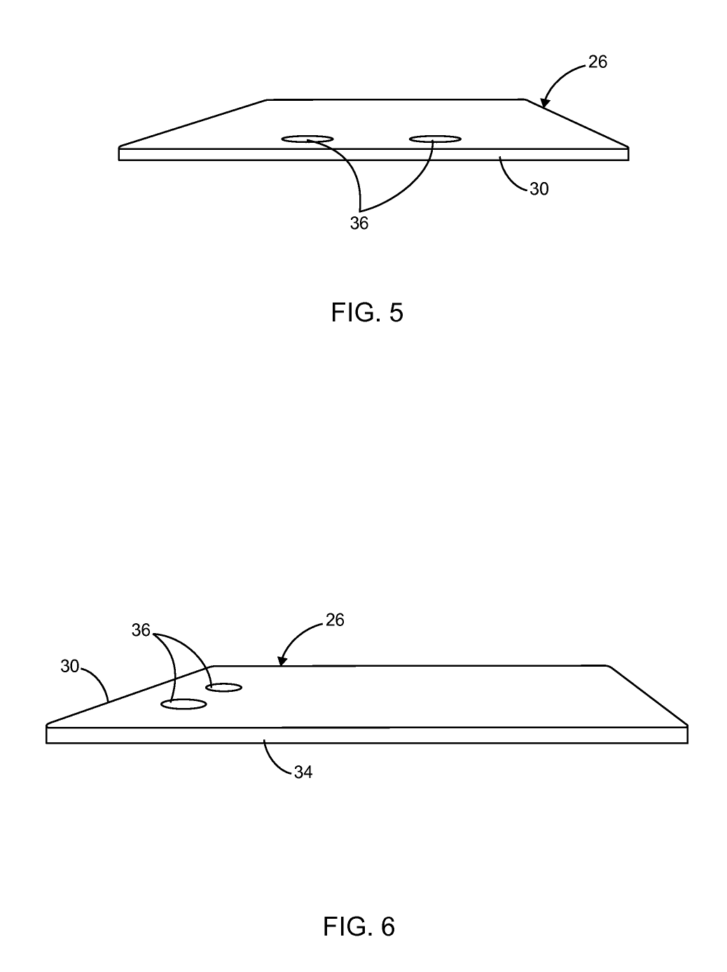

FIGS. 5 and 6 illustrate perspective views of the simulated divided light window gauge 26. The simulated divided light window gauge 26 is generally rectangular and of a pre-defined width and height. The width and height of the simulated divided light window gauge 26 is equivalent to the opening in the simulated divided light window grid 10 space. Each of the divided light window gauge 26 is placed between adjacent pair of rigid muntin bars 12. Generally the thickness of the window gauge 26 is the same thickness as the rigid muntin bars 12. The grasping means 36 on the window gauge 26 makes it easy to pick up and remove the simulated divided light window gauge 26 once the grid structure 10 is constructed. Users can select from different designs of grasping means 36 based on their convenience. Knobs or handles on the window gauge 26 are available for quick and easy handling. The alternate embodiment has two holes near the top edge 30 of the simulated divided light window gauge 26 of sufficient size to permit the worker to pick up the gauge. The holes also allow for the easy storage of the simulated divided light window gauge 26 on a peg. A three hold configuration in an embodiment provides even more convenient handling of the simulated divided light window gauge 26.

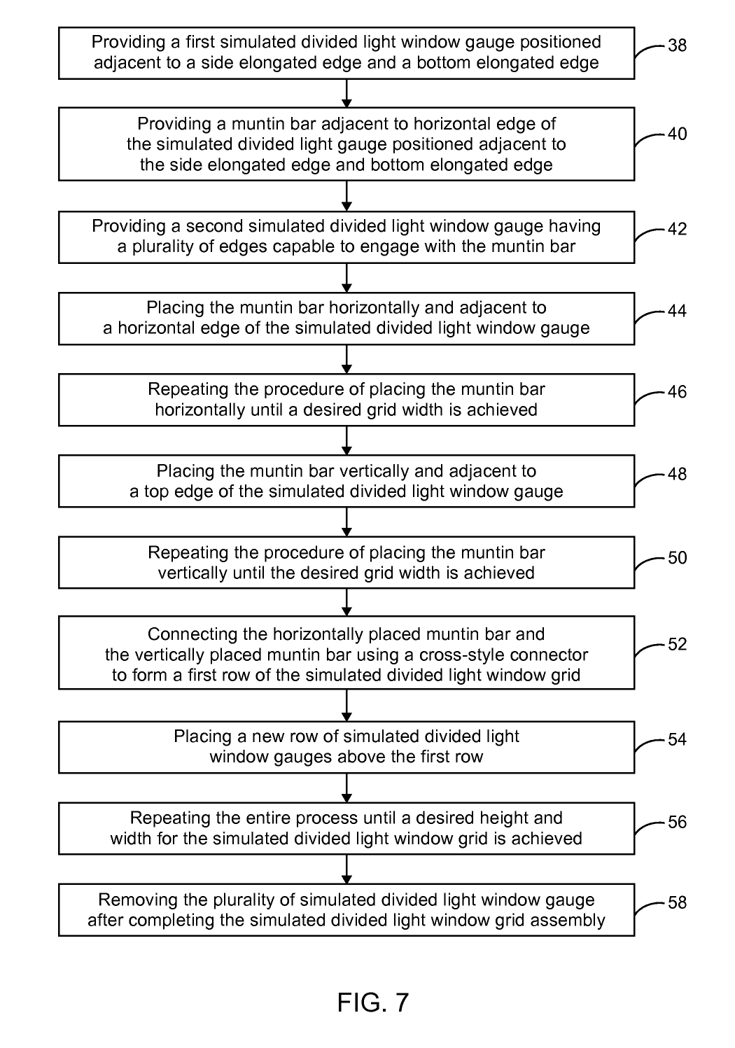

FIG. 7 illustrates an operational flow chart of a method of assembling the simulated divided light window grid assembly in accordance with the aspect of the preferred embodiment of the present invention. The method starts by providing a first simulated divided light window gauge positioned adjacent to a side elongated edge and a bottom elongated edge, where the side elongated edge and the bottom elongated edge are substantially perpendicular to each other. Then a muntin bar is positioned adjacent to the vertical edge of the simulated divided light window gauge. A second simulated divided light window gauge is then placed next to the first vertically positioned muntin bar and against the bottom elongated edge. This process is repeated until the desired width of the window muntin is achieved. Window muntin bars and cross-style connectors are then placed adjacent to the top edge of the simulated divided light gauge thereby connecting the vertically placed muntin bars with the horizontally placed muntin bars. Then a new row is started by placing a simulated divided light window gauge adjacent to the side elongated edge and adjacent to a previously placed horizontal muntin bar. Then the above said processes are repeated until a desired height and width for the simulated divided light window grid is achieved as indicated at block 56. Once the pre-determined size of the simulated divided light window grid is achieved, the plurality of simulated divided light window gauges are easily removed as indicated at block 58.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, a wide range of rigid muntin bar designs and simulated divided light window gauge designs may be obtained by varying the shapes of the edges of the window gauges and by accordingly varying the shape of the grooves on the rigid muntin bars. This system can also be extended to other areas like advertising boards, door and window assembly etc. It is intended that the scope of the present invention not be limited by this detailed description, but by the claims and the equivalents to the claims appended hereto.

1-3. (canceled)

4. A window gauge for constructing an assembly of muntin bars comprising:
a top edge and a bottom edge that are substantially parallel to each other, a left side edge and a right side edge that are substantially parallel to each other; and the top edge and the bottom edge are substantially perpendicular to the left side edge and the right side edge;
a thickness substantially equal to the thickness of the muntin bars; and,
three holes passing through the window gauge.

5. (canceled)

6. A window gauge for constructing an assembly of muntin bars according to claim 4 wherein the window gauge is constructed of plastic.

7. A window gauge for constructing an assembly of muntin bars according to claim 4 wherein the window gauge is a rectangular and the length of the top edge and bottom edge do not equal the length of the left side edge and right side edge.

8. A window gauge for constructing an assembly of muntin bars according to claim 4 wherein the window gauge is a square and the length of the top edge and bottom edge equal the length of the left side edge and right side edge.

9. A window gauge for constructing an assembly of muntin bars comprising:
a three sided triangular shape;
a uniform thickness substantially equal to the thickness of a muntin bars; and,
grasping means for removing the window gauge from the assembly of muntin bars.

10. A window gauge for constructing an assembly of muntin bars accordingly to claim 9 wherein the grasping means is three holes passing through the window gauge.

11. A window gauge for constructing an assembly of muntin bars accordingly to claim 9 wherein the three sided triangular shape is of a fixed non-adjustable size.

12. A window gauge for constructing an assembly of muntin bars according to claim 9 wherein the window gauge is constructed of plastic.

13. A window gauge for constructing an assembly of muntin bars comprising:
a square shape with a top edge and a bottom edge that are substantially parallel to each other, a left side edge and a right side edge that are substantially parallel to each other; and the top edge and the bottom edge are substantially perpendicular to the left side edge and the right side edge;
a thickness substantially equal to the thickness of the muntin bars; and,
three holes passing through the window gauge.
